(19) United States
(12) Patent Application Publication
(10) Pub. No.: US 2005/0223341 A1
(43) Pub. Date: Oct. 6, 2005

(54) Method of indicating loading status of application views, electronic device and computer program product

(76) Inventor: Mikko Repka, Oulu (FI)

Correspondence Address: CRAWFORD MAUNU PLLC, 1270 NORTHLAND DRIVE, SUITE 390, ST. PAUL, MN, 55120, US

(21) Appl. No.: 10/813,279

(22) Filed: Mar. 30, 2004

(51) Int. Cl. G06F 3/00

(52) U.S. Cl. 715/851; 715/808; 715/809; 715/810

(57) ABSTRACT

A method of indicating loading status of application views in an electronic device, an electronic device, and a computer program product. The control unit of the electronic device is configured to provide a floatable control area for controlling given software functions of the electronic device on the display, detect a start of an application view loading function, indicate information relating to the application view loading function on the floatable control area when the application view loading function is active, and when the application view loading function ends, display the loaded application view and end the indication of the information relating to the application view loading function on the floatable control area.

### BACKGROUND OF THE INVENTION

1. Field of the Invention

The invention relates to a method of indicating loading status of application views in an electronic device, an electronic device, and to a computer program product for providing indicating loading status of application views in an electronic device.

2. Description of the Related Art

The significance of different displays, for example, touch screens, is becoming more and more important in portable electronic devices. Portable devices are more and more used when loading application views, such as web page views, for example. Browsing on the Internet is an example of where the usability of a display is critical. It may take a long time to load web pages and this time cannot be pre-estimated by the user. Especially if the connection is slow, for example, when using a slow modem, a PDA (Personal Digital Assistant) device or a mobile phone, it is vital for the user to know that the requested loading function is being performed, that is, that the web page is being downloaded, and that the device is not halted. Further, different information relating to the loading function is important to the user. Information about the rate or speed of downloading, for example, and information on how much has been loaded and how much is still left to be downloaded would be useful to the user of the device.

Further, the sizes of different portable electronic devices are limited, and therefore also the sizes of the displays used in such devices are usually far from corresponding displays used in personal computers. Due to the limited sizes of the displays, the users also need to scroll a lot when navigating on the Internet, for example. Small display sizes also lead to smaller fonts, which in turn leads to using zooming features of the devices.

Because of the above-mentioned reasons, a need for an informative, simple and space-saving solution for showing downloading status exists.

### SUMMARY OF THE INVENTION

According to an aspect of the invention, there is provided a method of indicating loading status of application views in an electronic device. The method comprises providing a floatable control area for controlling given software functions of the electronic device, detecting a start of an application view loading function, indicating information relating to the application view loading function on the floatable control area when the application view loading function is active, and displaying the loaded application view and ending the indication of the information relating to the application view loading function on the floatable control area when the application view loading function ends.

According to another aspect of the invention, there is provided an electronic device comprising a control unit for controlling functions of electronic device, a display for showing application views coupled to the control unit, and an input device for giving control commands coupled to the control unit. The control unit is configured to provide a floatable control area for controlling given software functions of the electronic device on the display, detect a start of an application view loading function, indicate information relating to the application view loading function on the floatable control area when the application view loading function is active, and when the application view loading function ends display the loaded application view and end the indication of the information relating to the application view loading function on the floatable control area.

According to another embodiment of the invention, there is provided. a computer program product encoding a computer process for indicating loading status of application views in an electronic device. The computer process comprises providing a floatable control area for controlling given software functions of the electronic device, detecting a start of an application view loading function, indicating information relating to the application view loading function on the floatable control area when the application view loading function is active, and when the application view loading function ends displaying the loaded application view and ending the indication of the information relating to the application view loading function on the floatable control area.

According to an embodiment of the invention, there is provided an electronic device comprising controlling means for controlling functions of the user interface, displaying means for showing application views, and input means for giving control commands. The controlling means are further configured to provide a floatable control area for controlling given software functions of the electronic device on a display, detect a start of an application view loading function, indicate information relating to the application view loading function on the floatable control area when the application view loading function is active, and when the application view loading function ends, display the loaded application view and end the indication of the information relating to the application view loading function on the floatable control area.

The embodiments of the invention provide several advantages. Different functions of the device can be performed by using a single tool. The user can also customize the tool. Space is saved in the display of the device. A simple way of indicating information relating to an application view loading function is achieved. Further, from the point of view of the user, the invention is quickly understandable and easy to learn and use.

### BRIEF DESCRIPTION OF THE DRAWINGS

In the following, the invention will be described in greater detail with reference to the preferred embodiments and the accompanying drawings, in which

FIG. 1 shows an example of an electronic device;

FIGS. 2A and 2B illustrate examples of user interfaces of the invention, and

FIG. 3 shows an example of a method of indicating loading status of application views in an electronic device.

### DETAILED DESCRIPTION OF THE PREFERRED EMBODIMENTS

The embodiments of the invention are applicable. to electronic devices, such as a mobile station used as a terminal in telecommunication systems comprising one or more base stations and terminals communicating with the base stations, for example. The device may be used for short-range communication implemented with a Bluetooth chip, an infrared or WLAN connection, for example. The electronic device is for example a portable telephone or another device including telecommunication means, such as a portable computer, a personal computer, a handheld computer or a smart telephone. The portable electronic device may be a PDA (Personal Digital Assistant) device including the necessary telecommunication means for establishing a network connection, or a PDA device that can be coupled to a mobile telephone, for instance, for a network connection. The portable electronic device may also be a computer or PDA device including no telecommunication means.

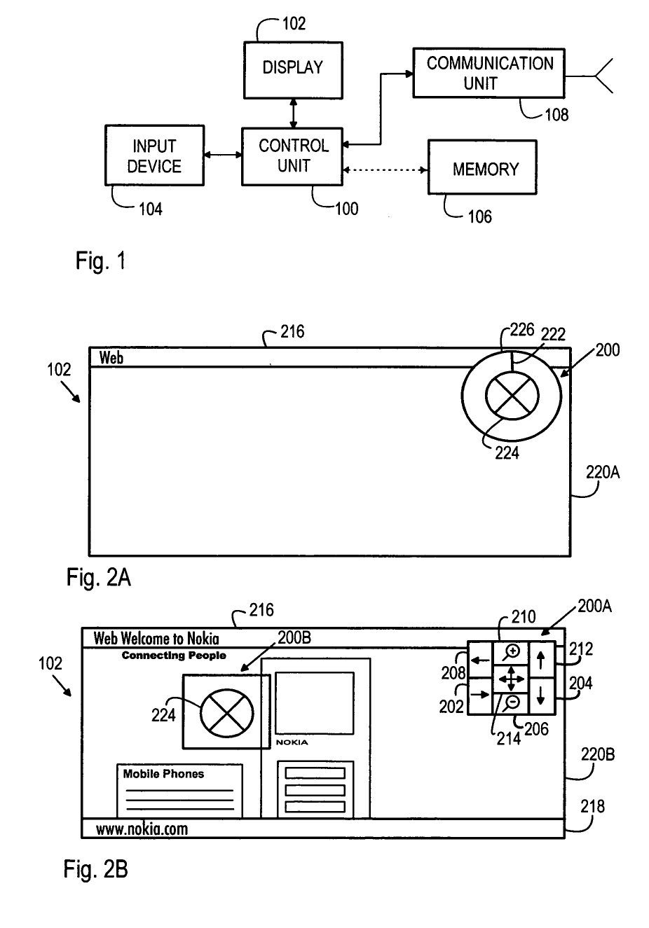

FIG. 1 shows a block diagram of the structure of an electronic device. A control unit 100, typically implemented by means of a micro-processor and software or separate components, controls the basic functions of the device. A user interface of the device comprises an input device 104 and a display 102, such as a touch screen implemented in manners known per se. In addition, the user interface of the device may include a loudspeaker and a keypad part. Depending on the type of the device, there may be different and a different number of user interface parts. The device of FIG. 1, such as a mobile station, also includes communication means 108 that implement the functions of a mobile station and include speech and channel coders, modulators and RF parts. The device may also comprise an antenna and a memory 106.

The functions of the device are controlled by means of the input device 104, such as a mouse, a hand-held locator operated by moving it on a surface. When using a mouse, for example, a sign or a symbol shows the location of a mouse cursor on the display 102 and often also the function running in the device, or its state. It is also possible that the display 102 itself is the input device 104 achieved by means of a touch screen such that the desired functions are selected by touching the desired objects visible on the display 102. A touch on the display 102 may be carried out by means of a pen, a stylus or a finger, for example. The input device 104 can also be achieved by using eye tracking means where detection of eye movements is used in interpreting certain control commands.

The control unit 100 controls the functions of the user interface and is connected to the display 102 and configured to show different application views on the display 102. The control unit 100 receives control commands from the input device 104. The input device 104 is configured to give control commands for loading application views to be shown on the display 102. The application views may be views into different web pages downloaded from the Internet, views from any application programs run in the device or any other application views that may be shown on the display 102. The loaded application views may be navigated or browsed by scrolling the application view horizontally or vertically, zooming in to the application view to get a better view of the details of the application view or zooming out from the application view to get a more general view of the whole application view.

The desired functions, such as loading or navigating, are first selected by means of the input device 104. Then, the control unit 100 interprets the detected selections, performs given software functions based thereon and, as a result of the performed software functions, displays a given application view on the display 104.

In an embodiment of the invention the control unit 100 is configured to provide a floatable control area for controlling given software functions of the electronic device on the display 102. The floatable control area may comprise control blocks for controlling given software functions. The control unit 100 detects selections of given control blocks indicated by the input device 104. The selection may be detected on the basis of a touch on the display 102, for example. Alternatively, the selection may be detected by means of the input device 104, such as a mouse or a pen. The control blocks may be for navigating in the application views shown on the display 102, for example. The control blocks may also be used for starting the application view loading function, for example.

The control unit 100 detects a start of an application view loading function, and indicates information relating to the application view loading function on the floatable control area when the application view loading function is in process. The information relating to the application view loading function may comprise information on the status and speed of the loading function. In an embodiment, the floatable control area turns into a combined download progress indicator and a stop/cancel button, for example. Thus, the user may follow the progress of the loading function and cancel the loading function from the same floatable control area. The floatable control area may also comprise control blocks for navigating in the application views, for example. In an embodiment, the control blocks relating to functions other than loading application views may be hidden when the loading function is active. In an embodiment, as a result of the loading function, given data may be saved, for example, and the information relating to the loading function may thus be information about the progress of a saving function, for example. The user may have started to save a document, and then he/she may easily follow the advancing of the saving function.

When the application view loading function ends, the control unit 100 is configured to display the loaded application view and end indicating, i.e. return to the default or previous state, the information relating to the application view loading function on the floatable control area.

The control unit 100 continues to detect control commands indicated by the input device 102, and to detect selections of given control blocks. It is possible that the floatable control area is displayed automatically partly over the application view shown on the display 102 when a given application program is opened. It is also possible that the floatable control area is opened separately by using an icon, a menu function or by tap-based activation.

Let us next study embodiments of the invention by means of FIGS. 2A and 2B. FIGS. 2A and 2B show displays 102 of an electronic device, such as a PDA device.

A display 102 is divided into. different areas, each area having specific functions. Application views are shown in the largest areas 220A and 220B, for example. There may be different bars 216, 218 for displaying different information or menus on the display 102.

In FIG. 2A, the floatable control area 200 is in the form of a circle. The floatable control areas 200A, 200B in FIG. 2B are in the form of squares. The floatable control areas 200, 200A, 200B may also be of any other shape than that of a circle or a square. The floatable control areas 200, 200A, 200B may comprise control blocks 202, 204, 206, 208, 210, 212, 214, 224 for controlling given software functions.

In an embodiment, the floatable control area 200 is provided and shown in the display 102 when a start of an application view loading function has been detected. The floatable control area 200 indicates information relating to the application view loading function when the application view. loading function is active. In FIG. 2A, the floatable control area 200 comprises a control block 224 for interrupting the loading function. In an embodiment, the user may at any time interrupt the loading function by selecting the control block 224, for example. The control block 224 for interrupting the loading function appears only when the loading function is active. In an embodiment, the information relating to the loading function may be shown anywhere in the floatable control area 200. In FIG. 2A, an area 226 is for indicating information on the progressing of the loading function, for example. The progress of the loading function may be indicated, for example, by filling the area 226 as the loading function proceeds, starting from and ending to a line 222, for example. When the application view loading function ends, the loaded application view is displayed and the indication of the information relating to the application view loading function on the floatable control area 200 is ended.

In an embodiment, the floatable control area 200A may comprise different control blocks for controlling given software functions of the device. In FIG. 2B, the control blocks 202 and 208 control horizontal scrolling of the application view and the control blocks 204 and 212 control vertical scrolling of the application view. In this example, the control blocks 206 and 210 control zooming in and zooming out. It is possible that tapping a pen down on a given control block 202, 208 for scrolling results in scrolling to the desired direction by a single predetermined step. Holding the pen down on the control block 202, 208 may repeat the functionality. Accordingly, tapping a pen down on a given control block 206, 210 for zooming results in changing the zoom level by a single predetermined step, and holding the pen down repeats the functionality.

The number of control blocks 202, 204, 206, 208, 210, 212, 214 may be different than in this example. There may also be control functions for the control blocks 202, 204, 206, 208, 210, 212, 214 other than those in these examples. All the control blocks that are needed in the device may reside in the same area, that is, in the floatable control area 200, 200A, 200B, for example.

In an embodiment of the invention, the floatable control area 200A comprises a control block 214 for changing the location of the floatable control area 200A in the display 102. In FIG. 2B, the control block 214 for changing the location of the floatable control area 200A is in the middle of the floatable control area 200A. The location of the floatable control area 200A may be changed for example by dragging and dropping the floatable control area 200A with the help of the control block 214. Tapping on the control block 214 and holding the pen down while dragging may move the floatable control area 200A to a desired location. For example, in FIG. 2B the location of the floatable control area 200A may be changed to a location of the floatable control area 200B.

The appearance of the floatable control area 200, 200A, 200B may be set as desired. In the example of FIG. 2B, the control blocks 202, 204, 206, 208, 210, 212, 214 for different functions are marked with individual icons, such as arrows up and down for control blocks 212, 204 for vertical scrolling, arrows left and right for control blocks for horizontal scrolling 208, 202, magnifiers for control blocks 210, 206 for zooming in or out, and crossed arrows for the control area 214. The control blocks 202, 204, 206, 208, 210, 212, 214 may also be marked with appropriate colors, text, drawings or fill effects. It is also possible that no icons are used and only different colors are used to identify the different functions of the control blocks 202, 204, 206, 208, 210, 212, 214. For example, different function groups, such as scrolling, zooming and moving, may have their own colors in addition to icons like arrows and magnifiers.

The floatable control area 200, 200A, 200B may also be set to appear in a “ghost mode”, meaning for example that all the icons are removed and only colours are used to indicate different control blocks. The whole floatable control area 200, 200A, 200B may be semi-transparent, that is, the contents below the floatable control area 200, 200A, 200B are visible. The level of transparency may also be adjusted. Thus, the floatable control area 200, 200A, 200B does not cover very much of the application view shown on the display 102. It is also possible that no colors, arrows or magnifiers are shown such that only some or all outlines of the different control blocks 202, 204, 206, 208, 210, 212, 214 are visible. As an example of the “ghost mode”, FIG. 2B shows the floatable control area 200B in a “ghost mode”. The application view 220B can be seen through the floatable control area 200B.

The loaded application view 220B may, for example, be a view to a web page on the Internet. The floatable control area 200 is displayed at least partly over the application view 220B. The location and size of the floatable control area 200A may be determined by using the user interface of the device, for example. It is possible that each time an application view is loaded the floatable control area 200A is displayed in a given location, for example, in the upper right corner of the display 104. It is also possible that the location may be changed at any time by using the control block 214. It is also possible that the changed location remains in the memory and the floatable control area 200A is next displayed in that changed location. Pressing or touching the control block 214 with a pen, for example, and moving the pen along the surface of the display 102 may result in changing the location of the floatable control area 200A. The size of the floatable control area 200A may also be set appropriately, for example, according to the needs of individual users of the device. The user may choose between a large and a small floatable control area 200, 200A, 200B, for example.

In the example of FIG. 2B, the floatable control area 200A is provided in the display 102. When the loading function is not active, the floatable control area 200A comprises the control blocks 202, 204, 206, 208, 210, 212 and 214 shown on the display. The user, for example, wishes to load a given application view to a web page and starts a loading function. The loading function may be started by giving an address to a web page, by selecting an address from a list, from a menu or by choosing a link from another web page view. Once the control unit has detected the start of the loading function, the appearance of the floatable control area 200A changes looking like the floatable control area 200B. Thus, during the loading function, only the control block 224 for interrupting the loading function is shown in the floatable control area 200B, for example. It is possible to indicate different information relating to the loading function in the floatable control area 200B during the loading function. Such information may be the status and rate of the loading function. Also, information indicating that the loading function is really proceeding may be shown on the floatable control area 200B. Thus, the user may be aware of the progress of the loading function and even of how long he/she has to wait before the loading of a given application view is completed.

When the application view loading function ends, the loaded application view is displayed on the display 102 and the indication of the information relating to the application view loading function on the floatable control area 200B is ended. In an embodiment, the appearance of the floatable control area 200B may change back to that of the floatable control area 200A comprising the different control blocks 202, 204, 206, 208, 210, 212, 214. Thus, the user may control the view of the loaded application view by using the control blocks 202, 204, 206, 208, 210, 212, 214. In an embodiment, the appearance of the floatable control area 200B may also change to that of some other state. The other state may be an application dependent state. For example, game or music applications may have different kind of application dependent states.

In an embodiment, also other control functions may be quickly selected by using the floatable control area 200, 200A, 200B. For example, pressing a secondary mouse button on a given control block 202, 204, 206, 208, 210, 212, 214 may result in opening a selection list or a menu where different control functions may be selected. If a touch screen or a pressure sensitive pen is used, holding a pen down on a control block 214 and holding the pen without moving may activate a given control function, such as opening of the selection list. The different topics on the selection lists or menus may be related to the floating control area 200, 200A, 200B, to the control blocks 202, 204, 206, 208, 210, 212, 214, loading functions and different settings. All the settings and functions that are needed are easily reachable by using such selection lists. Examples of the control functions that may be included in the selection lists include toggling between a full screen and a normal view, hiding the floatable control area 200, 200A, 200B, selecting the ghost mode, setting the size and appearance of the floatable control area 200, 200A, 200B, etc. Selecting a given topic from the selection list results in performing the function in question and then closing the selection list, for example. Also, tapping outside the selection list may cancel the action and close the selection list.

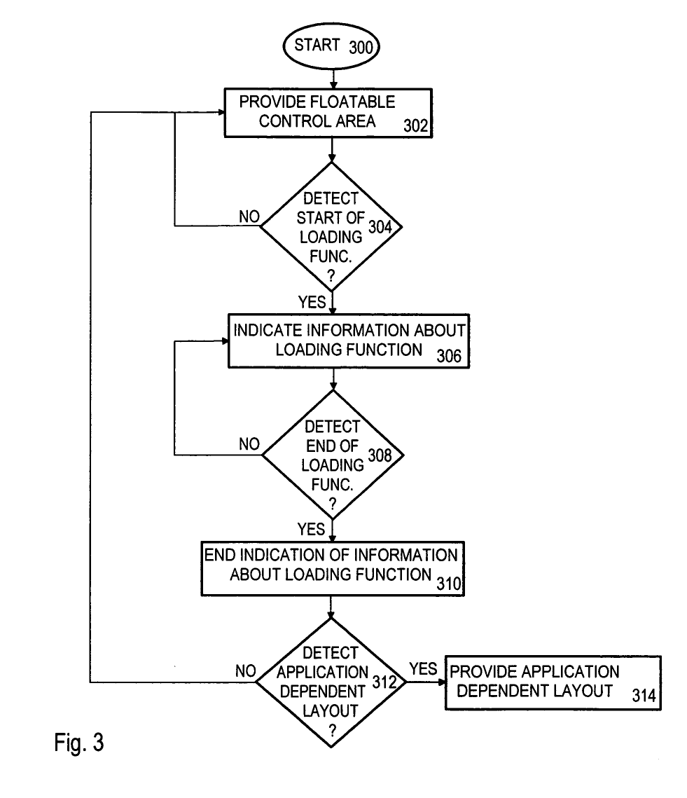

FIG. 3 shows an example of a method of indicating loading status of application views in an electronic device.

The method starts is 300. In 302, a floatable control area is provided on the display. The floatable control area may be displayed at least partly over the application views shown on the display. The floatable control area may be displayed automatically when an application view is shown on the display, for example. It is also possible that the floatable control area is first shown as an icon on the display, is activated on the menu or tap based activation on screen, and is selected when needed. In 304, if a start of an application view loading function is detected, 306 is entered. If no start of the application loading function is detected, the process remains in 302.

In 306, information relating to the loading function is indicated on the floatable control area. In 308, if the end of the loading function is detected, 310 is entered. The end of the loading function may be detected when the application view is loaded or when the loading function is interrupted. In 310, the indication of the information relating to the loading function is ended and the loaded application view may be shown on the display. If, in 312, an application dependent layout is detected, 314 is entered. In 314, the application view may be closed, or another application view or a layout may be opened, for example. If, in 312, no application dependent layout is detected, then 302 is re-entered where the floatable control area is provided on the display.

Even though the invention has been described above with reference to the example according to the accompanying drawings, it is clear that the invention is not restricted thereto but can be modified in several ways within the scope of the appended claims.

1. A method of indicating loading status of application views in an electronic device, the method comprising:
providing a floatable control area for controlling given software functions of the electronic device;
detecting a start of an application view loading function;
indicating information relating to the application view loading function on the floatable control area when the application view loading function is active; and
displaying the loaded application view and ending the indication of the information relating to the application view loading function on the floatable control area, when the application view loading function ends.

2. The method of claim 1, wherein the information relating to the application view loading function comprises information on the status, rate, the progress or duration of the application view loading function.

3. The method of claim 1, the method comprising displaying the floatable control area at least partly over the application views shown on the display.

4. The method of claim 1, the method further comprising providing a control block for interrupting the loading function in the floatable control area when the loading function is in process; interrupting the loading function on the basis of a detected control command from the control block for interrupting the loading function; and ending the indication of the information relating to the application view loading function on the floatable control area when the loading function is interrupted.

5. The method of claim 1, the method further comprising providing in the floatable control area a control block for changing the location of the floatable control area; and changing the location of the floatable control area on the basis of detected control commands from the control block for changing the location of the floatable control area.

6. The method of claim 1, the method further comprising providing control blocks for controlling given application view navigation functions in the floatable control area.

7. The method of claim 4, the method further comprising hiding the control blocks for controlling given application view navigation functions when the application view is loading.

8. The method of claim 1, the method further comprising displaying the floatable control area semi-transparently on the display.

9. The method of claim 1, the method further comprising displaying outlines of the floatable control area on the display.

10. An electronic device comprising:
a control unit for controlling functions of electronic device,
a display for showing application views coupled to the control unit, and
an input device for giving control commands coupled to the control unit,
wherein the control unit is configured to provide a floatable control area for controlling given software functions of the electronic device on the display, detect a start of an application view loading function, indicate information relating to the application view loading function on the floatable control area when the application view loading function is active, and when the application view loading function ends, display the loaded application view and end the indication of the information relating to the application view loading function on the floatable control area.

11. The electronic device of claim 10, wherein the information relating to the application view loading function comprises information on the status, rate, progress or duration of the application view loading function.

12. The electronic device of claim 10, wherein the control unit is further configured to display the floatable control area at least partly over the application views shown on the display.

13. The electronic device of claim 10, wherein the control unit is further configured to provide a control block for interrupting the loading function in the floatable control area when the loading function is in process; interrupt the loading function on the basis of a detected control command from the control block for interrupting the loading function; and end the indication of the information relating to the application view loading function on the floatable control area when the loading function is interrupted.

14. The electronic device of claim 10, wherein the control unit is further configured to provide in the floatable control area a control block for changing the location of the floatable control area; and change the location of the floatable control area on the basis of detected control commands from the control block for changing the location of the floatable control area.

15. The electronic device of claim 10, wherein the control unit is further configured to provide control blocks for controlling given application view navigation functions in the floatable control area.

16. The electronic device of claim 15, wherein the control unit is further configured to hide the control blocks for controlling given application view navigation functions when the application view is loading.

17. The electronic device of claim 10, wherein the control unit is further configured to display the floatable control area semi-transparently on the display.

18. The electronic device of claim 10, wherein the control unit is further configured to display outlines of the floatable control area on the display.

19. A computer program product encoding a computer process for indicating loading status of application views in an electronic device, the computer process comprising:
providing a floatable control area for controlling given software functions of the electronic device;
detecting a start of an application view loading function;
indicating information relating to the application view loading function on the floatable control area when the application view loading function is active; and
when the application view loading function ends displaying the loaded application view and ending the indication of the information relating to the application view loading function on the floatable control area.

20. An electronic device comprising
controlling means for controlling functions of a user interface,
displaying means for showing application views, and
input means for giving control commands,
the controlling means being further configured to provide a floatable control area for controlling given software functions of the electronic device on the display, detect a start of an application view loading function, indicate information relating to the application view loading function on the floatable control area when the application view loading function is active, and when the application view loading function ends, display the loaded application view and end the indication of the information relating to the application view loading function on the floatable control area.
